(19) United States
(12) Patent Application Publication
(10) Pub. No.: US 2021/0263604 A1
(43) Pub. Date: Aug. 26, 2021

(54) METHOD, APPARATUS AND SYSTEM FOR GENERATING A TIME-DEPENDENT SIGNAL ON A SURFACE SENSOR

(71) Applicant: Prismade Labs Gmbh, Chemnitz (DE)

(72) Inventors: Karin Weigelt, Chemnitz (DE); Jan Thiele, Chemnitz (DE)

(73) Assignee: Prismade Labs Gmbh, Chemnitz (DE)

(21) Appl. No.: 17/276,301

(22) PCT Filed: Sep. 17, 2019
(86) PCT No.: PCT/EP2019/074785

§ 371 Date: Mar. 15, 2021

(30) Foreign Application Priority Data
Sep. 17, 2018 (EP) 18000748.6

(51) Int. Cl. G06F 3/044; G06F 3/039; G06F 3/041

(52) U.S. Cl. CPC G06F 3/044; G06F 3/0416; G06F 3/0393

(57) ABSTRACT

A device is provided that includes an electrically conductive structure on a non-conductive substrate for generating a time-dependent signal on a capacitive surface sensor. A method for generating a tamper-proof time-dependent signal on a surface sensor is also provided by means of such a device. A system or kit for carrying out the method and generating a time-dependent, tamper-proof signal on a capacitive surface sensor is also provided.

The invention relates to a device comprising an electrically conductive structure on a non-conductive substrate for generating a time-dependent signal on a capacitive surface sensor, a method for generating a tamper-proof time-dependent signal on a surface sensor by means of such a device, and a system or kit for carrying out the method and generating a time-dependent, tamper-proof signal on a capacitive surface sensor.

### STATE OF THE ART

In 2010, data carriers were disclosed for the first time that can be read by capacitive touchscreens such as those found in commercially available smartphones and tablets. The following state of the art has since developed in this area:

WO 2011 154524 A1 describes a system for transmitting information from an information carrier to a capacitive surface sensor. The information carrier has an electrically conductive layer on an electrically non-conductive substrate, the electrically conductive layer being designed as a “touch structure” and comprising at least one touch point, a coupling surface and/or a conductor track. The touch points replicate the characteristics of fingertips. In addition to the system, the use of the system is described, as well as a method for capturing information based on a static or dynamic interaction between the surface sensor and the information carrier. The document discloses the coding of the information, which is based in particular on the positions of the sub-regions.

WO 2012 072648 A1 describes a method for capturing information from an information carrier using a capacitive touch screen. The application relates essentially to a system similar to the aforementioned prior art. The described information carrier consists essentially of two different materials that differ in terms of conductivity or dielectric coefficient. Relative movement between the information carrier and the touch screen causes an interaction between the information carrier and the surface sensor, based on the different material properties, which generates a touch signal. Likewise, in this document, the electrically conductive pattern includes the basic elements of touch points, coupling area and conductive traces, where the conductive traces connect the touch points to each other and/or to the coupling area.

WO 2016 131963 A1 describes a capacitive information carrier comprising first and second electrically conductive regions that are at least partially connected to each other. At least two subregions of the first electrically conductive region cover at least two different intersections of transmitting and receiving electrodes of the touchscreen.

All of the above applications commonly have the basic idea of using the electrically conductive structure, which is arranged on an information carrier, to simulate the properties of fingertips and thus enable the information carriers to be read out on capacitive touchscreens. Since corresponding touchscreens were thus used “for purposes other than intended,” it was necessary to adapt the electrically conductive structures to such an extent that the touchscreen could perceive corresponding inputs through the electrically conductive structure and not “filter them out.” The basic idea in the prior art documents is based on geometric coding, in which the relative position of the electrically conductive elements of the electrically conductive structures among each other essentially forms the basis of the coding/decoding.

WO 2018 141478 A1 describes a method for generating a time-dependent signal on a capacitive surface sensor whose conductive structure consists of many individual elements and the time-dependent signal is generated by a relative movement between an input means and the card-like object. WO 2018 141479 A1 discloses a device for generating a time-dependent signal on a capacitive surface sensor. Both applications mandatorily provide for an input means that is in dynamic operative contact with the electrically conductive structure. Furthermore, the inventions described in WO 2018 141478 A1 and WO 2018 141479 A1 are based on the generation of a single touch signal.

The object of the present invention is to provide a device and a system for generating a time-dependent signal on a capacitive surface sensor that does not have the disadvantages and shortcomings of the prior art. Furthermore, the device to be provided is intended to provide a particularly intuitive and user-friendly interactive object that can be verified and/or identified using a capacitive surface sensor. A further object of the present invention is to provide a particularly tamper-proof device, as well as a system and a method by which a particularly tamper-proof verification and/or identification of devices or the users of the device associated therewith can be performed.

### DESCRIPTION OF THE INVENTION

The objective is solved by the features of the independent claims. Advantageous embodiments of the invention are described in the dependent claims.

According to the invention, a device for generating a time-dependent signal on a capacitive surface sensor is provided, the device comprising an electrically conductive structure on a non-conductive substrate. The device is characterized in that the electrically conductive structure of the device generates a set of substantially static signals on the capacitive surface sensor, and the static signals are deflected and converted into dynamic signals by an additional dynamic input with an input means. It was completely surprising that a particularly tamper-proof time-dependent signal can be generated with the proposed device and the three-dimensional object, respectively.

The invention therefore preferably also relates to a method for generating a tamper-proof time-dependent signal on a surface sensor comprising the following steps:
a) Providing an apparatus having a capacitive surface sensor and a device comprising an electrically conductive structure having structural elements on a non-conductive substrate for generating static signals on the capacitive surface sensor
b) Placing the device on the surface sensor, generating a set of static signals on the surface sensor,
c) Providing a dynamic input in the form of a movement and/or a gesture with an input means for generating an input signal which is suitable for deflecting the static signals on the capacitive surface sensor and converting them into dynamic signals, the dynamic input signal and the dynamic signals representing a time-dependent overall signal which can be evaluated by the device containing the surface sensor.

Advantageously, the provision of such a tamper-proof signal allows for particularly secure verification and/or identification of devices or their associated users.

In the sense of the invention, the term “identification” preferably means that a device is recognized by the surface sensor and can be assigned, for example, to a data record stored in the electrical apparatus containing the surface sensor. In this context, the data record may, for example, also not be stored directly in the electrical apparatus, but may be accessible to it, for example by being retrievable on a server, on the Internet and/or in a cloud. The detection of the device by the surface sensor is performed in particular by the detection of the electrically conductive structure arranged on the device in conjunction with the dynamic input. In particular, the electrically conductive structure is determined by the arrangement of individual regions. The electrically conductive structure therefore preferably represents an identification code, which can be used for authentication or verification purposes.

In particular, it was surprising and represents a significant advantage of the invention that the set of deflected signals as well as the dynamic input signal generated by the additional input through the input means in total produce a complex and particularly tamper-proof (i.e. secure against manipulation) overall signal. Another significant advantage of the invention is that the conversion from static to dynamic signals can be performed on virtually all surface sensors that have been tested. Thus, the proposed invention can be used on any kind of touchscreen and mobile devices and is particularly universal in use, which is especially advantageous if the invention is to reach a wide range of users.

It is preferred in the sense of the invention that a dynamic input signal is generated with the additional dynamic input, preferably performed with an input means. For the term dynamic input signal, the term time-dependent input signal or likewise input signal is used synonymously. The generation of an input signal by means of an input means may be, for example, the movement of a user's finger along an edge of the three-dimensional object when the object rests on the surface sensor. It was completely surprising that the movement of a user finger, i.e., an input means, has an effect on the system comprising the device and the surface sensor, even though the electrically conductive structure is preferably not present at the edge along which the input means is moved. In other words, it is preferred in the sense of the invention that the input means simultaneously touches the device and the screen of the surface sensor, but that there is no direct contact with the electrically conductive structure, which is preferably present on another side surface of the three-dimensional object. In this respect, the invention causes an interaction between the electrically conductive structure of the device and the input means, although the input means does not touch the electrically conductive structure at all, which is surprising. Preferably said interaction is brought about indirectly via the electrode grid of the capacitive surface sensor.

Preferably, the additional dynamic input by means of input means in the sense of the invention may also be referred to as the second dynamic input. It is preferred in the sense of the invention that the set of dynamic signals and the input signal form a total dynamic signal, which is advantageously obtained by the synergistic interaction of the electrically conductive structure and the capacitive surface sensor. The overall signal is preferably referred to in the sense of the invention as a “time-dependent signal” which can be generated by the device. Preferably, the time-dependency manifests itself in that the signal assumes different shapes or forms at different times.

It is preferred in the sense of the invention that the electrically conductive structure is present on the device and is arranged to generate the set of esstentially static signals on the capacitive surface sensor. Preferably, an additional dynamic input performed by an input means is arranged to deflect the static signals and convert them into dynamic signals. The deflection is preferably manifested by the fact that an initially static signal caused by a prominent structural element of the electrically conductive structure on the surface sensor then becomes a dynamic signal when an input means moving along the edge of the device is at the same level as the prominent structural element. When the input means is at the same level as the prominent structural element, both the structural element and the input means interact simultaneously with a selected transmitting and/or reading electrode, which is preferably a prerequisite for deflecting the static signal and converting said static signal into a dynamic signal. A distinctive structural element may be, for example, an easily perceived and recognized component of the electrically conductive structure. It is preferably a selected geometric element or region of the structure that preferably stands out from the rest of the structure.

In an exemplary, concrete embodiment of the invention, the dynamic signal appears initially as a static signal caused by a structural element of the electrically conductive structure, and subsequently starts to wobble and to move in particular in the direction of the input means and preferably along the electrically conductive structural element, when the input means is at the same height as the structural element. The designation “at the same height” means that the input means is in operative contact at the respective time either with the same row or with the same column of the surface sensor as the respective structural element. If, for example, the initially static signal consists in a point-shaped signal with a resting position on the screen of the surface sensor, the corresponding dynamic signal may consist in a “jittering” signal, i.e. a signal that shifts locally with time, which is shifted in particular in the direction of the input means. If the input means continues to move and is present at a later time at the level of another structural element of the electrically conductive structure, the dynamic signal preferably moves back to its initial position, stops jiggling and again becomes a static signal at rest.

In a preferred embodiment of the method, the dynamic input comprises guiding the input means over the surface sensor, which comprises at least sweeping over the rows and/or columns of the electrode grid on which the structural elements of the device are present positioned.

It is preferred in the sense of the invention that the static signals are caused in particular by the placement of the device on the capacitive surface sensor and the design of the electrically conductive structure on the device establishes the static signal on the surface sensor. It is particularly preferred in the sense of the invention that the static signals are determined in particular by the design of the electrically conductive structural elements on the device on the surface sensor. It is preferred in the sense of the invention that the electrically conductive structure is at least partially in operative contact with the capacitive surface sensor. In other words, the elements of the electrically conductive structure in the regions of the surface sensor where the elements of the electrically conductive structure rest on the screen of the surface sensor cause the charge carrier distribution within the electrode grid of the surface sensor to be influenced. The deliberate and targeted influencing of the charge carrier distribution within the electrode grid of the surface sensor is preferably referred to as a generation of signals in the sense of the invention. The regions of the surface sensor in which a charge carrier shift is caused by elements of the electrically conductive structure may also preferably be referred to as “activated” regions or areas in the sense of the invention.

The dynamic input, which is performed after placing the device on the capacitive surface sensor and which is in particular arranged to cause a deflection of the static signals, whereby dynamic signals are obtained, is in the sense of the invention preferably the movement of an input means on or along the proposed device, wherein the electrically conductive structure is preferably arranged on the device in such a way that the input means is not in direct operative contact with the electrically conductive structure during the dynamic input. It is particularly preferred in the sense of the invention that the input by means of the input means is dynamic or is carried out dynamically. In addition to the fingers, special input pens or similar objects can also be used as input means. These are preferably capable of causing a local charge shift between transmitting and receiving electrodes within the surface sensor. These transmitting and receiving electrodes within the surface sensor are preferably referred to as the surface sensor electrode grid, and form the rows and columns of the surface sensor electrode grid. The surface sensor is preferably arranged to detect the position of the input means.

It is particularly preferred in the sense of the invention that the dynamic input causes a local charge shift within the surface sensor, which causes the deflection of the static signals or their conversion into dynamic signals. The proposed approach, i.e., the generation of static signals by an electrically conductive structure and the deflection and conversion of the static signals, causes a local change in charge density or a local change in charge, respectively, which in the context of the present invention is exploited to generate a surprisingly tamper-proof overall signal resulting from said additional dynamic input. In particular, in the context of the present invention, a seemingly undesirable signal deflection is exploited to provide increased tamper resistance of a signal or data transmission. In this regard, the invention departs from the known prior art, which has previously sought to avoid the occurrence of such deflection phenomena. It was thus surprising to find that the present invention can be used as a means of signal enhancement.

For this purpose, it is particularly preferred in the sense of the invention that the additional dynamic input is in the form of a movement or gesture, the movement or gesture being performed in particular with the input means. The movement may be, for example, a sliding, wiping, stroking, pulling or pushing movement, without being limited thereto. In the context of the present invention it is intended that the dynamic input is performed by a substantially continuous movement of an input means along a transition region between the device and the surface sensor, the transition region being formed in particular by an edge of a preferably cuboid object. The edge may be formed in particular by a bottom side and a side surface of the object. The movement preferably takes place on the surface of the capacitive surface sensor. In the context of the present invention, the input means is in operative contact with the electrode grid of the capacitive surface sensor during the movement and gradually overlaps various rows and/or columns of the electrode grid, i.e. the input means interacts with selected rows and/or columns of the electrode grid of the capacitive surface sensor during the movement.

Preferably, it is intended that the device is a three-dimensional object, which may, for example, have a cuboid shape. For example, the three-dimensional object may be a package or a folding box. In particular, it is preferred in the sense of the invention that the three-dimensional object has a bottom side, wherein the electrically conductive structure is preferably arranged on said bottom side and an adjacent side surface of the three-dimensional object. It is particularly preferred in the sense of the invention that the three-dimensional object is designed for having an edge to be used as a guide for an input with the input means, which is preferably realized by providing the dynamic input by substantially continuously moving an input means along a transition region between the device and the surface sensor.

The term “essentially continuous movement” is not unclear to the person skilled in the art, since the person skilled in the art knows how an input means, for example a finger, is moved on a smartphone or along an edge of a cuboid package.

It is further preferably intended that the device is a card-shaped object. For example, the device may be a paper or plastic card. It is particularly preferred in the sense of the invention that the electrically conductive structure is preferably present on the bottom side, the top side or in a middle layer of the card-shaped object. It is particularly preferred in the sense of the invention that the card-shaped object is adapted for having an edge to be used as a guide for input with the input means, which is preferably realized by the dynamic input being performed by a substantially continuous movement of an input means along a transition region between the device and the surface sensor. The term “ essentially continuous movement” is not unclear to the person skilled in the art, since the person skilled in the art knows how an input means, for example a finger, is moved on a smartphone, respectively along an edge of a card-shaped object.

For the purposes of the invention, the term “capacitive surface sensor” preferably refers to input interfaces of electronic devices. A preferred embodiment of a “capacitive surface sensor” is a touch screen, which in addition to serving as an input interface also serves as an output device or display. Devices with a capacitive surface sensor are able to perceive external influences or impacts, for example touches or contacts on the surface, and evaluate them by means of an attached electronic logic. Such surface sensors are used, for example, to make machines easier to operate. Typically, surface sensors are provided in an electronic device, wherein the electronic devices can be without limitation smartphones, cell phones, displays, tablet PCs, tablet notebooks, touchpad devices, graphics tablets, televisions, PDAs, MP3 players, trackpads and/or capacitive input devices.

The term “apparatus including a surface sensor” or “apparatus with a surface sensor” preferably refers to electronic devices, such as those aforementioned, which are capable of a further evaluation of the information provided by the capacitive surface sensor. In preferred embodiments the electronic devices are mobile devices.

Touchscreens are preferably referred to also as surface sensors or sensor screens. A surface sensor need not necessarily be used in conjunction with a display or a touchscreen. It may also be preferred in the sense of the invention that the surface sensor is integrated visibly or non-visibly in apparatus, objects and/or devices.

Surface sensors comprise in particular at least one active circuit, preferably referred to as a touch controller, which may be connected to a structure of electrodes. Surface sensors are known in the prior art whose electrodes comprise groups of electrodes which differ from one another, for example in their function. In the sense of the invention the electrode structure is preferably referred to as an “electrode grid”. It is preferred in the sense of the invention that the electrode grid of a surface sensor comprises groups of electrodes, the groups of electrodes differing from one another, for example, in their function. The electrodes may be, for example, transmitting and receiving electrodes which, in a particularly preferred design, may be arranged as columns and rows, that is, in particular, forming nodes or intersections at which at least one transmitting and one receiving electrode intersect or overlap. Preferably, the intersecting transmitting and receiving electrodes are aligned with one another in the region of the nodes in such a way that they enclose with one another angles of substantially 90°.

Terms such as substantially, approximately, about, etc. preferably describe a tolerance range of less than ±20%, preferably less than ±10%, even more preferably less than ±5% and in particular less than ±1%. Statements such as substantially, approximately, about, etc. always also disclose and include the exact value mentioned.

It is particularly preferred in the sense of the invention that an electrostatic field is formed between the transmitting and receiving electrodes of the surface sensor, which reacts sensitively to changes, such as, for example, by bringing the surface of a surface sensor into contact with an electrically conductive object or by grounding (outflow of electrical charge) the surface of a surface sensor.

It is preferred in the sense of the invention that the touch controller controls the electrodes in such a way that an electric field is formed between each of the one or more transmitting electrodes and one or more receiving electrodes. The electric field within the surface sensor can be changed by placing the device and in particular the electrically conductive structure on the surface of the surface sensor and/or by an additional dynamic input by means of input means. Generally speaking the electric field between the electrodes is locally reduced, i.e. “charges are removed”, by touching the surface of a surface sensor with a finger or an electrically conductive object. This can be done, for example, by placing or bringing into contact a proposed device according to the present invention on a surface sensor, so that the electrically conductive structure of the device generates a set of essentially static signals on the capacitive surface sensor and the static signals are deflected and converted into dynamic signals by an additional dynamic input using input means. It is preferred in the sense of the invention that at different times different areas or prominent structural elements of the electrically conductive structure are at the same level with the input means, i.e. in operative contact with the same row or same column of the electrode grid. It is particularly preferred in the sense of the invention that the electrically conductive structure is arranged and/or positioned on the three-dimensional object in such a way that the input means is not in direct operative contact with the electrically conductive structure during the dynamic input. In other words, it may be preferred in the sense of the invention that the input means is in indirect operative contact with the electrically conductive structure during the additional dynamic input via the rows and/or columns of the electrode grid of the capacitive surface sensor. For the purposes of the invention, the term indirect operative contact is preferably to be understood to mean that the electrically conductive structure and the input means are not in direct or immediate contact, but that the connection between the conductive structure and the input means is established indirectly via an electrode row or electrode column of the capacitive surface sensor. In other words, indirect operative contact between the electrically conductive structure and the input means denotes that at a time t a part of the electrically conductive structure is in operative contact with an electrode row and/or electrode column and at the same time t the input means is in operative contact with the same electrode row and/or electrode column without the input means and electrically conductive structure being in direct contact.

Preferably, the dynamic input activates different regions of the electrically conductive structure in the sense that the regions become “visible” to the surface sensor even though the input means does not touch the electrically conductive structure at all. The phenomena of becoming visible is for due to a coupling between the capacitive surface sensor of the electrically conductive structure when, for example, a grounding of the device is made, which can lead to a change of the electrostatic field between the electrodes in the surface sensor and/or to a measurable change of the capacitance. Typically, the signal is reduced because the input means and/or the electrically conductive structure absorbs a portion of the signal from the transmitting electrode, resulting in a lower signal arriving at the receiving electrode. In the context of the present invention, the change in the electrostatic field may be caused, for example, by the dynamic input. It is preferred in the sense of the invention that the dynamic input causes the static signals generated by the electrically conductive structure to be deflected and converted into dynamic signals. It is particularly preferred in the sense of the invention that the deflection of the static signals occurs at a time t when the respective regions or structural elements of the electrically conductive structure and the input means are in interaction with a same row and/or a same column of an electrode grid of the capacitive surface sensor. For example, the respective regions of the electrically conductive structure may be individual prominent structural elements of the electrically conductive structure. In a particularly preferred embodiment of the invention, the change of the electrostatic field may be effected by the indirect operative contact between the electrically conductive structure and the input means. It may further be preferred that a change in the electrostatic field is caused by the additional dynamic input.

For example, the electrically conductive structure of the device may generate a set of essentially static signals on the capacitive surface sensor, the positions of which are preferably detected by the surface sensor at the position at which they are actually present on the surface sensor. However, when a dynamic input is made using an input means through an indirect operative contact, the surface sensor “sees” other positions, i.e., the surface sensor assigns positions to the static signals that differ from the actual positions determined by the arrangement of the electrically conductive structure on the device. The described deviation is referred to as deflection or distortion in the sense of the invention. In particular, the deviations occur when the input means with which the dynamic input is made is at the same level as the respective structural element, which in the sense of the invention means that the selected structural element and the input means are in interaction with a same row and/or a same column of an electrode grid of the capacitive surface sensor. It became apparent that the initially static signals caused by the structural elements on the surface sensor as long as no dynamic input is made, are pulled towards the input means and/or start to wobble when the dynamic input is performed. The resulting dynamic signal forms for example along the structural element of the electrically conductive structure, i.e., the signal is pulled along the structural element toward the input means. Said surprising effect was not expected by a person skilled in the art neither in principle, nor in its universality or in its extent

Surface sensors in particular comprise at least one active circuit, preferably referred to as a touch controller, which may be connected to a structure of electrodes. The electrode structure is preferably also referred to as an “electrode grid” for the purposes of the invention. Surface sensors are known in the prior art whose electrodes comprise groups of electrodes which differ from one another, for example, in their function. These may be, for example, transmitting and receiving electrodes which, in a particularly preferred arrangement, may be arranged in column and row form, that is, in particular, form nodes or intersections at which at least one transmitting and one receiving electrode -each intersect or overlap. Preferably, the intersecting transmitting and receiving electrodes are aligned with respect to each other in the region of the nodes in such a way that they form an angle of essentially 90° with one another. It is particularly preferred in the sense of the invention that an electrostatic field is formed between the transmitting and receiving electrodes of the surface sensor, which is sensitive to changes. Said changes can be caused, for example, by touching the surface of the surface sensor with a finger or a conductive object, by touching a touching or grasping surface of an electrically conductive structure which is at least partially located on the surface sensor, or in particular by bringing the surface sensor into contact with an electrically conductive structure which is arranged, for example, on the bottom side of a device. In particular, such changes lead to potential changes within the electrostatic field, which is preferably caused by the fact that, for example, the electric field between the transmitting and receiving electrodes is locally reduced by contacting a contact surface of an electrically conductive structure. Such a change in the potential conditions is detected and further processed by the electronics of the touch controller.

It is preferred in the sense of the invention that the touch controller controls the electrodes in such a way that a signal is transmitted between each of one or more transmitting electrodes and one or more receiving electrodes, whose signal can preferably be an electrical signal, for example a voltage, a current or a potential (difference). These electrical signals in a capacitive surface sensor are preferably evaluated by the touch controller and processed for the operating system of the apparatus. The information transmitted by the touch controller to the operating system describes so-called individual “touches” or “touch events”, each of which can be thought of as individual detected touches or can be described as individual inputs. Said touches are preferably characterized by the parameters “x-coordinate of touch”, “y-coordinate of touch”, “timestamp of touch” and “type of touch”. The “x-coordinate” and “y-coordinate” parameters describe the position of the input on the touchscreen. Each pair of coordinates is preferably assigned a timestamp that describes when the input occurred at the corresponding position. The “type of touch” parameter describes the detected state of the input on the touchscreen. The person skilled in the art is familiar with the types Touch Start, Touch Move, Touch End and Touch Cancel, among others. With the help of the parameters Touch Start, at least one Touch Move and Touch End as well as the associated coordinates and time stamps, a touch input on the capacitive surface sensor can be described. It is preferred that multiple touch inputs can be evaluated simultaneously, known in the prior art as multitouch technology. Projected capacitance touch technology (PCT) is an exemplary technology that allows multi-touch operation.

In preferred embodiments of the method, the set of touch events or touches are processed and evaluated using a software program (‘app’). The evaluation may comprise several steps. Preferably, first the device parameters of the apparatus which includes the surface sensor, e.g. the resolution of the touch screen, are determined. Depending on the apparatus, the signal comprising a set of touch events is preferably pre-filtered in the next step and specific characteristics of the signal are amplified or adjusted. Subsequently, the signal is checked for plausibility by calculating parameters such as temporal course of the signal, velocity and data density and reviewing them for possible manipulation and comparing them with known threshold values. It is preferred that subsequently various characteristic values and parameters of the signal are determined or calculated, including the characteristic values start of the signal, end of the signal, local maxima and minima, local velocities of the signal, displacement, amplitudes, if necessary period length of periodic signals and if necessary further characteristics, in order to convert the signal into a comparable data set. In particular, it is preferred to subsequently compare this data set with other data sets and to assign it to a known data set located, for example, in a database, and thus to decode the signal. In a further preferred embodiment, the matching of the data set takes place using a machine learning model (artificial neural networks) previously created from recordings. In particular, it was surprising that the use of a machine learning model to decode the signal is particularly suitable for complex signals with many different parameters.

The decoding of the signal preferably comprises an assignment of the detected time-dependent overall signal to a known electrically conductive structure or an identification code represented thereby. Advantageously, it became apparent that the complex time-dependent overall signal obtained by means of the dynamic input is particularly tamper-proof. An imitation of the complex time-dependent overall signal with another electrically conductive structure (i.e. without presentation of the identification code) is almost impossible.

The method is therefore particularly suitable for authentication methods, for example, to grant a user access to information or an action when the device is placed on a mobile device and a dynamic input is performed in accordance with the invention.

In a preferred embodiment of the invention, the electrically conductive structure in general and the structural elements of the electrically conductive structure in particular are designed in such a way that the dynamic signals generated in the capacitive surface sensor are suitable for being evaluated with the aid of an algorithm in a data processing system. The structural elements can be designed in various ways.

In a preferred embodiment, the structural elements are line-shaped. The linear structural elements are preferably characterized by a width of at least 0.5 mm and at most 8 mm, particularly preferably by a width of greater than 1.5 mm and less than 5 mm. The length of the structural elements can preferably be varied over a wider range. Decisive boundary conditions are, for example, the contact surface of the device on the capacitive surface sensor and the size of the capacitive surface sensor. In a preferred embodiment, the length of the structural elements is at least 5 mm.

In particularly preferred embodiments, the electrically conductive structure does not include any regions that have a diameter of more than 8 mm, preferably more than 5 mm. In the prior art, for example, it was preferred to imitate in the form of so-called touch points the properties of fingertips in order to generate touch events. However, the inventors have recognized that regions of larger surface area with a range of more than 8 mm are not conducive to the deflection of static signals as envisaged in the invention: Due to the relatively high area, the provision of an additional dynamic input leads only to minor deflections, which are more complex to detect. In contrast, the described electrically conductive structure with thin linear structural elements is characterized by improved sensitivity and capacity to be deflected by the dynamic input described herein, e.g. by means of a finger.

In addition, linear structural elements are preferably characterized by the angle at which they are arranged on the device.

In a preferred embodiment, the structural elements are arranged orthogonally +/−75° to the edge of the device along which the input means is moved.

Particularly preferred is the arrangement of the structural elements perpendicular to the edge of the device along which the input means is moved, such an arrangement being characterized by a +/−45° angle. The average person skilled in the art knows that the angular values mentioned are values of about 75 or 45°, since the person skilled in the art knows that angular values can vary or deviate by +/−2 to 5°, for example, due to measurement inaccuracies. It is particularly preferred that the structural elements do not extend to the edge of the device along which the input means is moved.

In a preferred embodiment, the device has at least one edge for guiding the input means and specifying a dynamic input signal, the structural elements being linear and having an angle of ±75°, preferably ±45°, with the orthogonal of the edge, the structural elements particularly preferably having an angle with the orthogonal of between 5° and 75°, especially preferably between 10° and 45°. It is therefore particularly preferred that the structural elements are oriented neither at an angle of 0° nor exactly 90° to the edge and thus to the dynamic input. Instead, it became apparent that an inclined, angled orientation to the edge leads to particularly well detectable and characteristic deflections.

In a preferred embodiment of the invention, the electrically conductive structure is self-contained (connected) and does not consist of multiple individual elements. In other words, the electrically conductive structure exhibits a non-interrupted contour line. It is particularly preferred that the structural elements of the electrically conductive structure are designed and arranged to be in operative contact with the capacitive surface sensor. If the device is a three-dimensional object, for example a packaging or a folding box, in a preferred embodiment the structural elements are arranged on the bottom side of the packaging and are connected to one another via a further region of the electrically conductive structure, arranged on a side surface of the three-dimensional object.

In a further preferred embodiment, the structural elements are arranged exclusively on one side of the device. For example, if the device is a card-shaped object, the entire electrically conductive structure is arranged on the bottom or top side of the card-shaped object.

In further embodiments, it may be preferred to subdivide the electrically conductive structure and arrange multiple individual parts of the electrically conductive structure on the device. For example, one part of the electrically conductive structure may be arranged on one edge of the device and another part of the electrically conductive structure may be arranged on another edge of the device.

It is particularly preferred in the sense of the invention that the device is formed by a card-shaped object. It is further preferred that the card-shaped object is referred to as the “object” in short. Preferably, the card-shaped object is a cuboidal structure characterized by a smaller height of the object compared to the width and length of the object. Preferably, the side of the object facing the surface sensor is referred to as the bottom side of the object, while the side of the object opposite to the bottom side is referred to as the top side of the object.

It is particularly preferred in the sense of the invention that the device or the three-dimensional object is formed by a package or a folding box. It is further preferred that the three-dimensional object is referred to as an “object” in short. Preferably, the object is a cuboidal structure having, in particular, six side surfaces. The side surface of the object facing the surface sensor is preferably referred to as the bottom surface of the object, while the side surface of the object opposite the bottom surface is referred to as the top surface of the object. The remaining four side surfaces are preferably referred to as side surfaces.

It is preferred in the sense of the invention that the device is based on an electrically non-conductive substrate material. Preferably, papers, cardboards, folding boxboards and/or stickers, labels, foil materials, laminates and/or further materials are used as substrate material without being limited thereto.

It is preferred in the sense of the invention that the electrically conductive structure be applied to a substrate material by means of foil transfer methods, for example cold foil transfer, hot stamping and/or thermal transfer, without being limited to these application methods. In particular, printing methods, for example and without limitation offset printing, gravure printing, flexographic printing, screen printing, and/or inkjet methods may be used to produce the electrically conductive structure on the non-conductive substrate. Suitable electrically conductive inks include materials based on, for example metal particles, nanoparticles, carbon, graphene, and/or electrically conductive polymers without being limited to these materials. It may also be preferred in the sense of the invention to cover the electrically conductive structure by at least one further layer. The layer may be a paper- or film-based laminate material or at least one paint/lacquer layer. The layer may be optically transparent or opaque.

It is preferred in the sense of the invention that the electrically conductive structure is applied directly to the substrate material of the device, i.e., for example, applied directly to the folding boxboard on the inside or outside. It is further preferred, in a further embodiment, to apply the electrically conductive structure to a sticker or label material and to apply said sticker to the device. In a further embodiment, such a sticker is applied to the packaging as a first opening protection or tamper (manipulation) protection in such a way that the sticker material and thus also the electrically conductive structure are interrupted, for example at an edge, during a first opening.

One feature of classic conventional printing processes is the simple and fast reproduction of a motif. Herein the motif to be printed is applied to a printing form, for example gravure cylinders or offset printing plates, and subsequently reproduced a plurality of times at high speed. Conventional printing processes are not suitable for producing individualized content, since the production of the printing forms represents a significant proportion of the total production costs. As a consequence only large runs of a print product can be produced economically. In graphic printing, digital printing processes exist for the production of short runs as well as individualized products, with which individualized content can be printed economically. These printing processes include electrophotography, laser printing or inkjet printing, for example. It is also possible to produce individualized electrically conductive structures using process combinations of conventional printing processes and additive or subtractive processes.

The set of deviated positions assigned to static signals is referred to as a deviated signal in the sense of the invention. The assignment of positions deviating from an actual position on the three-dimensional object may also be referred to as conversion to a dynamic signal in the sense of the invention. It may be preferred in the sense of the invention that an interaction of points or positions takes place. It is particularly preferred in the sense of the invention that the static signals are generated substantially simultaneously when the device is placed on the surface sensor, and the static signals are deflected by the dynamic input with a time delay.

In a preferred embodiment, the invention relates to a device comprising an electrically conductive structure on a non-conductive substrate for generating a set of signals on a capacitive surface sensor, the signals being deflected by a second dynamic input with an input means on the capacitive surface sensor. It is preferred in the sense of the invention that the deflection of the static signals occurs at a time t when the respective regions of the electrically conductive structure and the input means are in interaction with a same row and/or a same column of an electrode grid of the capacitive surface sensor. It is preferred in the sense of the invention that the second dynamic input corresponds to the additional dynamic input with which preferably the input signal is obtained. It is preferred in the sense of the invention that the deflection of the static signals by the dynamic input is achieved by the dynamic input in that an effect and/or a position of the static signals on the surface sensor(s) is changed by the dynamic input, thereby obtaining dynamic signals. In particular, it is preferred in the sense of the invention to specifically use the resulting deflection for the conversion of the static signals into dynamic signals and thus, for example, to increase the data capacity and security against forgery or manipulation of the device.

A dynamic input can be represented on a surface sensor, for example in a coordinate system with two axes, which are designated x-axis for the horizontal axis and y-axis for the vertical axis according to mathematical conventions. Thus, a change in the x-coordinate preferably corresponds to a shift of a point to the right or left, while a change in the y-coordinate of a point corresponds to a shift up or down. When a finger of a user moves across the screen of a surface sensor, the actual movement and the signal detected by the surface sensor essentially coincide.

If, as described above, an xy coordinate system is mentally placed on the screen of a surface sensor, the actual positions of the static signals and the deflected positions detected by the surface sensor will have different progressions with respect to time, the deviations being in particular caused by the dynamic input. The inventors have recognized that when a dynamic input is made, a deflection of the static signals is obtained, which can be represented in the mental xy coordinate system described above.

It is particularly preferred in the sense of the invention that the electrically conductive structure determines a direction and an intensity of the deflection of the signals. In other words, the embodiment of the electrically conductive structure is adapted to determine the direction and the intensity of the deflection of the signals. In the sense of the invention, the term “direction of deflection” preferably describes the orientation of two spatial positions with respect to each other, wherein preferable one position is that of a static signal as “seen” by a surface sensor without additional dynamic input, and the other position is that of the static signal while or after additional dynamic input is applied. The second signal may be referred to as a deflected signal in the sense of the invention. It is preferred in the sense of the invention that a set, i.e. a plurality, of static signals are generated by the electrically conductive structure and deflected and converted by a dynamic input.

If, in the mental coordinate system described above, the original position of a static signal is described by the coordinate pair (x1/y1) and the deflected signal is described by the coordinate pair (x2/y2), the deflection can be described, for example, as a vector whose coordinates can be represented as the difference of the position coordinates. The x-coordinate of the deflection vector can be calculated, for example, as x=x2−x1 and the y-coordinate as y=y2−y1. Depending on whether the values obtained are positive or negative, i.e. greater or less than zero, the deflection is in the direction “right-up”, “right-down”, “left-up” or “left-down”, wherein for example: x, y>0 in the case of a deflection in the direction right-up.

In terms of the invention, the intensity of the deflection represents a measure of the magnitude of the deflection. In particular, deflections can be compared to each other based on the x and y coordinates of the deflection. In the sense of the invention, if a first deflection has a larger x and y coordinate than a second deflection, it is preferred that the first deflection exhibits a larger intensity than the second deflection.

In addition to the intensity, the deflection can also be characterized by the speed of the deflection. With the help of the coordinate pairs (x1/y1) before the deflection and (x2/y2) after the completed deflection as well as the corresponding time stamps t1 and t2, the velocity of the deflection can be determined. The velocity can represent a characteristic parameter which is influenced by the geometry of the structural element.

It is preferred in the sense of the invention that the electrically conductive structure comprises regions or structural elements, each region generating a respective static signal on the capacitive surface sensor, the initially static signals being characterized essentially by time stamp information as well as a set of coordinate pairs. In other words, it may be preferred that each region or structural element of the electrically conductive structure is arranged to generate a respective preferably static signal on the capacitive surface sensor.

The term “time stamp information” can be understood in the sense of the invention to mean that each coordinate point (x1, y1) and each deflection (x/y) can be assigned a time course, so that the coordinate points and the deflections or their coordinates can be described as functions of time: (x1(t), y1(t)) and (x(t)/y(t)), respectively. Thus, the term “time stamp information” in the sense of the invention comprises a set of at least three pieces of information, namely an x-coordinate, a y-coordinate and a time t, where the x-coordinate and the y-coordinate of a dynamic signal or a deflection can take different values at different times t1 and t2: x1=x(t1) and x2=x(t2), respectively, and y1=y(t1) and y2=y(t2).

It is particularly preferred in the sense of the invention that the device is suitable to be used as a guide for the movement of the input means along an edge of the device. In other words, the device may preferably be used as a guide for the movement of the input means along an edge of the device. For example, it may be preferred in the sense of the invention to place the device, which may for example be a cuboidal package, on a capacitive surface sensor and to swipe a finger, which may in the sense of the invention for example be considered as an input means, along a transition between the package and the surface sensor. The transition region may be formed, for example, by the 90 ° angle that the package preferably encloses with the surface sensor when the package is placed on the surface sensor. By moving the finger, i.e. the input means, along the transition region, preferably both the package and the surface sensor are touched simultaneously, but not the electrically conductive structure. It is preferred in the spirit of the invention that the input means does not directly touch the electrically conductive structure while making the dynamic input, preferably there is an indirect contact between the input means and the electrically conductive structure. The indirect contact between the input means and the electrically conductive structure is preferably established via the transmitting and receiving electrodes of the electrode grid of the capacitive surface sensor, whereby a capacitive coupling exists both between the input means and the electrode grid of the surface sensor and between the electrically conductive structure and the electrode grid.

In a preferred embodiment of the invention, a dynamic input is performed using two or more input means. For example, two fingers can be used, which are simultaneously guided along two edges of the device. In this way, a higher degree of complexity of the overall signal can be achieved, enabling even more precise identification.

In another aspect, the invention relates to a system for generating a time-dependent signal on a surface sensor, the system comprising a device described herein, an input means, and a capacitive surface sensor, and wherein the device comprises an electrically conductive structure. The system is characterized in that the device is adapted to generate a set of static signals on a capacitive surface sensor, wherein the static signals are deflected and converted into dynamic signals by an additional input using input means on the capacitive surface sensor.

Preferably, a system is provided for generating a tamper-proof, time-dependent signal on a capacitive surface sensor, the system comprising a device and an apparatus comprising a capacitive surface sensor, and wherein
a) the device comprises an electrically conductive structure having structural elements on a non-conductive substrate adapted to generate a set of static signals on the capacitive surface sensor,
b) the static signals can be deflected and converted into dynamic signals by an additional input by means of an input means on the capacitive surface sensor, and
c) the dynamic input signal generated by the input means and the dynamic signals represent a time-dependent overall signal which is evaluated by the apparatus containing the surface sensor.

It is preferred in the sense of the invention that the electrically conductive structure is in operative contact with the capacitive surface sensor or that the input means is in operative contact with the capacitive surface sensor. For the purposes of the invention, the term “operative contact” is preferably to be understood as meaning that the objects, for example an electrically conductive structure or an input means, have an effect on the surface sensor in the sense that changes occur in the electrostatic field formed between the transmitting and reading electrodes of the electrode grid of the surface sensor. For example, a set of static signals can be generated by placing the device on the surface sensor. In other words, an operative contact, for example, between the electrically conductive structure and the surface sensor or between the input means and the surface sensor advantageously causes the charge carrier distribution in the surface sensor to change locally, wherein said change in the charge carrier distribution can be evaluated by a logic or an evaluation unit in the surface sensor, for example, in order to determine and/or detect a deflection of signal positions or deflections in general. The evaluation unit in the surface sensor is preferably referred to as a touch controller in mobile devices.

It is preferred in the sense of the invention that the deflected time-dependent signals and the dynamic input signal are collectively referred to as the time-dependent overall signal. The time-dependent overall signal is evaluated in the apparatus containing the surface sensor and assigned, for example, to a data set (data record) in a database.

It is preferred in the sense of the invention that the static signals are caused in particular by the design of the electrically conductive structure on the device by the latter on the surface sensor when the device rests on the surface sensor. Preferably, the elements of the electrically conductive structure in the regions of the surface sensor where they rest on the screen of the surface sensor influence the charge carrier distribution within the electrode grid of the surface sensor. It is through this deliberate and purposeful manipulation of the charge carrier distribution within the electrode grid that the static signals are generated in the context of the present invention. The regions of the surface sensor in a which charge carrier shift is caused by elements of the electrically conductive structure can preferably also be referred to as “activated” regions in the context of the invention. The signals generated are preferably static, since the device with the electrically conductive structure is merely placed on the surface sensor, but is not moved. In this respect, there is a static operative contact between the device and the surface sensor due to the placement, whereas a dynamic operative contact or a dynamic input preferably requires a relative movement between the involved contact partners. It is preferred in the sense of the invention that the dynamic input is dynamic, since it is made in the form of a movement or a gesture. In other words, the input means is moved on the screen of the surface sensor or a gesture is performed therewith.

It is preferred in the sense of the invention that the activated areas, which preferably correspond to the positions of the static signals, shift as a result of the dynamic input. Said shift is preferably manifested by a changed charge carrier distribution within the surface sensor or its electrode grid, respectively; it is preferably also referred to as deflection and advantageously leads to a transformation of the formerly static signals into dynamic signals, since the signals caused by the electrically conductive structure during the dynamic input are, for example, wobbling or shifted in the direction of the input means. It is preferred in the sense of the invention that the deflection of the static signals occurs along the structural elements of the electrically conductive structure. It is preferred in the sense of the invention that the deflection of the static signals takes place at a time t at which the regions or elements of the electrically conductive structure as well as the input means interact with the same columns and/or rows of the electrode grid of the surface sensor. In the sense of the invention, the effect is preferably described by the formulation that the respective regions of the electrically conductive structure and the input means are at the same level. In other words, the deflection occurs when elements of the electrically conductive structure as well as the input means interact with the same transmitting electrodes and/or reading electrodes of the electrode grid. In the sense of the invention, this preferably means that deflection and conversion of the amount of static signals occurs when the electrically conductive structure, or a part thereof, and the input means are in contact, i.e. interact, with a transmitting electrode and/or with a reading electrode at the same time.

This can be illustrated by the following example: A proposed device comprises an electrically conductive structure having, for example, three prominent structural elements. The structural elements of the electrically conductive structure interact with the electrode grid of the surface sensor when the device is placed on the surface sensor. The corresponding areas on the surface sensor are activated, with the positions of these activated regions corresponding to the positions or centroids of the structural elements of the electrically conductive structure. A movement is now carried out on the surface sensor with the input means, for example a human finger, wherein the electrically conductive structure is preferably positioned on the device in such a way that the input means is not in direct operative contact with the electrically conductive structure during the dynamic input. In particular, a finger can be moved along the edge of the device that rests on the surface sensor, wherein the finger in particular does not touch the electrically conductive structure. In other words, the electrically conductive structure is in indirect operative contact with the input means during dynamic input via the rows and/or columns of the electrode grid. If the electrically conductive structure, or a part thereof, for example a structural element, and the input means simultaneously interact with a transmitting electrode and/or with a reading electrode, a deflection of that static signal occurs which is generated by the corresponding structural element of the electrically conductive structure. Thus, different static signals can be deflected and converted one after the other, whereby the sequence of deflections is determined by the dynamic input and the tangential transmitting and reading electrodes, respectively.

The system according to the invention is preferably adapted to detect and evaluate the described deflection of the static signals or the conversion into dynamic signals in order to identify or verify the applied electrical structure.

In a preferred embodiment, the system has a data processing device which is adapted to evaluate the time-dependent overall signal, the data processing device preferably having installed on it software (‘app’) which comprises commands to determine dynamic characteristics of the time-dependent overall signal and to compare them with reference data.

In a preferred embodiment, the apparatus containing the surface sensor has a data processing device which is adapted to evaluate the time-dependent overall signal, wherein on said data processing device preferably software (‘app’) is installed, which comprises commands to determine dynamic characteristics of the time-dependent overall signal and to compare them with reference data.

In a further preferred embodiment, the software is provided at least in part in the form of a cloud service or an internet service, wherein the apparatus transmits the touch data or touch events via the internet to an application in the cloud. Also in this case, software (‘app’) is presently installed on a data processing device comprising commands to determine dynamic characteristics of the time-dependent overall signal and to compare them with reference data. However, the software installed on the data processing device of the device does not perform all computationally intensive steps on the apparatus. Instead, the data about the time-dependent overall signal or the amount of touch events is transmitted to a software application in a cloud (with an external data processing device) for determining dynamic characteristics and comparing them with reference data.

The software as a cloud service, which preferably comprises commands to determine dynamic characteristics of the time-dependent overall signal and to compare them with reference data, processes the dynamic overall signal in the form of a set of touch events and sends the result back to the apparatus comprising the surface sensor or to the software installed on said apparatus. The software on the apparatus can preferably further process the results and control the display of the results.

When preferred features of the software are described below, a person skilled in the art recognizes that these preferably apply equally to software that performs the steps entirely on the apparatus and to software that has outsourced some (preferably computationally intensive) steps, such as the determination of dynamic characteristics and their comparison with reference data, to an external data processing device of a cloud service. A person skilled in the art recognizes that the intended evaluation of the overall time-dependent signal is to be understood as a unified concept, regardless of which steps of the algorithm are performed on the apparatus itself or by an external data processing device on a cloud. In preferred embodiments, for example, the dynamic characteristics of the time-dependent overall signal can also be determined by the software on the apparatus and only the comparison of the dynamic characteristics with reference data can be carried out outsourced by a cloud service.

The apparatus containing the surface sensor is preferably an electronic device which is able to further evaluate the information provided by the capacitive surface sensor. The capacitive surface sensor or the apparatus preferably comprise an active circuit, also referred to as a touch controller, which allows an evaluation of touch signals on the surface sensor as described above. By means of the touch controller and an operating system provided on the electronic device (apparatus), the time-dependent overall signal is preferably processed as a set of touch events.

A touch event preferably refers to a software event provided by the operating system of the device with the capacitive surface sensor when an electronic parameter detected by the touch controller changes.

An operating system preferably refers to the software that communicates with the hardware of the apparatus, in particular the capacitive surface sensor or touch controller, and enables other programs, such as software (‘app’) to run on the device. Examples of operating systems for apparatus (devices) with capacitive surface sensor are Apple's iOS for iPhone, iPad and iPod Touch or Android for running various smartphones, tablet computers or media players. Operating systems control and monitor the hardware of the apparatus, especially the capacitive surface sensor or a touch controller. Preferably, operating systems for the claimed system provide a set of touch events that reflect the overall time-dependent signal.

In the case of continuous dynamic input, for example, the dynamic input can be recognized as a touch start, a touch move, and touch end, and the x or y coordinates and the timestamps of the touches can be used to track the timing of the dynamic input.

Placing the device with an electrically conductive structure with structural elements preferably generates static signals on the surface sensor, which are also recognized as a set of touch events by the device. Depending on the design of the structural elements, these can generate one or more static signals or touch events. Before the dynamic input occurs, the x or y coordinate of the touches of the static signals will change only slightly. Minor changes may preferably occur due to variations in the detection or positioning of the device on the surface sensor.

As described above, a dynamic input, for example by means of a finger, causes a time-dependent deflection of the static signals. The dynamic signals are preferably also detected by the device as touch events, wherein, for example, the deflection of an already generated touch can be determined as a temporal change of the x,y coordinates.

The processing of the time-dependent overall signal, i.e. both the dynamic input and the deflected signals of the structural elements, is preferably performed by the operating system or the touch controller of the electronic device, such as a smartphone.

The software (‘app’) installed on the data processing device preferably evaluates the overall time-dependent signal based on the detected set of touch events.

The data processing device is preferably a unit which is suitable and configured for receiving, sending, storing and/or processing data, preferably touch events. The data processing unit preferably comprises an integrated circuit, a processor, a processor chip, a microprocessor and/or microcontroller for processing data, as well as a data memory, for example a hard disk, a random access memory (RAM), a read-only memory (ROM) or even a flash memory for storing the data. In commercially available electronic devices with surface sensors, such as the mobile devices or smart devices, corresponding data processing devices are present.

The software (‘app’) may be written in any programming language or model-based development environment, such as C/C++, C#, Objective-C, Java, Basic/VisualBasic, or Kotlin. The computer code may include subroutines written in a proprietary computer language specific to reading or controlling or other hardware component of the device.

In particular, the software preferably determines dynamic characteristics (dynamic characteristic values) of the time-dependent overall signal (preferably in the form of a set of touch events) in order to compare them with threshold values and/or reference data sets.

The dynamic characteristics (or dynamic characteristics values) can be, for example, a start, end, local maxima, local minima, local velocities, deflections and/or amplitudes of touch events.

The entirety of the dynamic characteristics characterizing the overall signal can preferably be combined in a data set which can be compared with a reference data set to identify or verify the applied electrical structure. In a preferred embodiment, the matching of the data set takes place using a machine learning model (artificial neural networks) previously created from recordings or calibration data. For example, reference data can be generated for this purpose by placing the device with a known electrical structure on a surface sensor and making a predetermined dynamic input, for example along an edge of the device.

The term reference data preferably includes threshold values or reference data sets. The term reference data preferably refers to all data that allows an assignment of a detected time-dependent overall signal to an identification code or a known electrical structure.

Preferably, the reference data may be stored on a computer-usable or computer-readable medium on the data processing unit. Any file format used in the industry may be suitable. The reference data may be stored in a separate file and/or integrated in the software (e.g., in the source code).

Due to the complexity of the time-dependent overall signal, such an assignment or identification is particularly secure and protected against manipulation (tamper-proof).

The identification methods known in the prior art are based in particular on the recognition of static signals from an electrical structure, for example a touch structure, which imitates the touch of fingertips. With sufficient skill, it is in principle possible to reproduce such touch structures with the fingers using the known methods or systems.

It is not possible to reproduce a time-dependent overall signal generated according to the invention without providing an identical electrical structure. Even if it were possible to reproduce the static signals of the structural elements by skillful application of fingers or other capacitive structures, the deflection due to a dynamic input would be significantly different. Advantageously, the displacement or deflection of the static signals depends directly on the capacitive properties of the structural elements. The change in charge carrier distribution resulting from a dynamic input is therefore unique for the respective structural elements and depends, for example, on their shape, size and orientation.

Based on the determination of dynamic characteristic values, the software can also perform a series of plausibility checks to rule out any manipulation of the signal.

For example, it may be preferred that the software evaluates the temporal course of the dynamic input signal and the dynamic signals and compares them to reference data to estimate the likelihood that a deflection of the static signal by the input signal will result in the detected temporal course of the dynamic signals.

As explained above, the deflection of the static signals by the dynamic input preferably occurs at a time t when the respective structural elements of the electrically conductive structure and the input means are in interaction with a same row and/or a same column of an electrode grid of the capacitive surface sensor.

In a preferred embodiment, the software can thus examine whether such a temporal correlation occurs between the detected dynamic input signal and the detected deflected dynamic signals of the structural elements. Furthermore, the software can determine, for example, the amplitude and/or orientation of the deflection of the static signals, during the sweep of the input means and preferably compare it with reference data. For example, the amplitude of the deflection may depend on both the distance of the dynamic input signal from the structural elements, and the total area of the respective structural elements. The orientation of the deflection is preferably in the direction of the input means, wherein the shape of the structural elements can lead to a slight but possibly characteristic weighting.

The determination of the dynamic characteristics of the time-dependent overall signal and the comparison with threshold values and/or reference data sets thus preferably allows both a check of the plausibility of the signal and its assignment to reference data for identification purposes. The evaluation by means of the software can be implemented in various ways and comprise several steps. Preferably, first the device parameters of the apparatus containing the surface sensor, e.g. the resolution of the surface sensor or touch screen, can be determined.

In this manner the overall signal comprising a set of touch events step is preferably pre-filtered and specific characteristics of the signal are amplified or adjusted. Advantageously, as a result the software is not limited to a specific type of apparatus, but can provide optimal results for different electronic devices.

After filtering the overall signal, the signal can be checked for plausibility by calculating parameters such as a temporal course of the signal, speed and data density. Based on a comparison with known or calibrated threshold values, any manipulation can thus be reliably excluded.

Particularly preferably, a series of diverse characteristics and parameters of the signals are then determined or calculated. For this purpose, among others, the characteristics start of the signal, end of the signal, local maxima and minima, local velocities of the signal, deflection, amplitudes, if necessary period length of periodic signals can be determined and, if necessary, combined with further characteristics on the overall signal into a data set. The dynamic characteristics should in particular be suitable to characterize the position of the static signals as well as their deflection (dynamic signals). Subsequently, the obtained data set and a reference data set, being provided for example in a database, can be compared to decode the overall signal, preferably using a machine learning algorithm. Decoding preferably means an assignment of the time-dependent overall signal to a known identification code or a known electrically conductive structure.

In a further aspect, the invention relates to a kit for carrying out a method described, comprising
a. a device comprising an electrically conductive structure with structural elements on a non-conductive substrate for generating a time-dependent overall signal on a capacitive surface sensor, wherein by placing the device on a capacitive surface sensor and a set of essentially static signals can be generated on the capacitive surface sensor, which can be deflected and converted into dynamic signals by an additional dynamic input by means of an input means
b. a software (‘app’) for installation on a device containing a surface sensor, comprising commands to determine dynamic characteristics of the time-dependent overall signal and to compare the dynamic characteristics with reference data.

Optionally, the kit may further comprise instructions for carrying out the described method, in particular for performing a dynamic input in the form of a movement and/or a gesture with an input means for generating an input signal suitable for deflecting the static signals on the capacitive surface sensor and converting them into dynamic signals so that the dynamic input signal generated by the input means and the dynamic signals represent a time-dependent overall signal.

The person will recognize that preferred embodiments and advantages disclosed in connection with the described method, device, system or kit carry over equally to the other claimed categories such as the method, device, system or kit. For example, preferred embodiments of the method use preferred embodiments of the device and result in the same benefits. Similarly, it is preferred that the system or kit use the described device or preferred embodiments thereof.

Further advantages, features and details of the invention are to be taken from the further dependent claims and the following description. Features mentioned can be relevant to the invention individually or in any combination. Thus, the disclosure relating to the individual aspects of the invention can always be referred to reciprocally. The drawings serve merely by way of example to clarify the invention and have no restrictive character.

The invention is described in more detail with reference to the following figures:

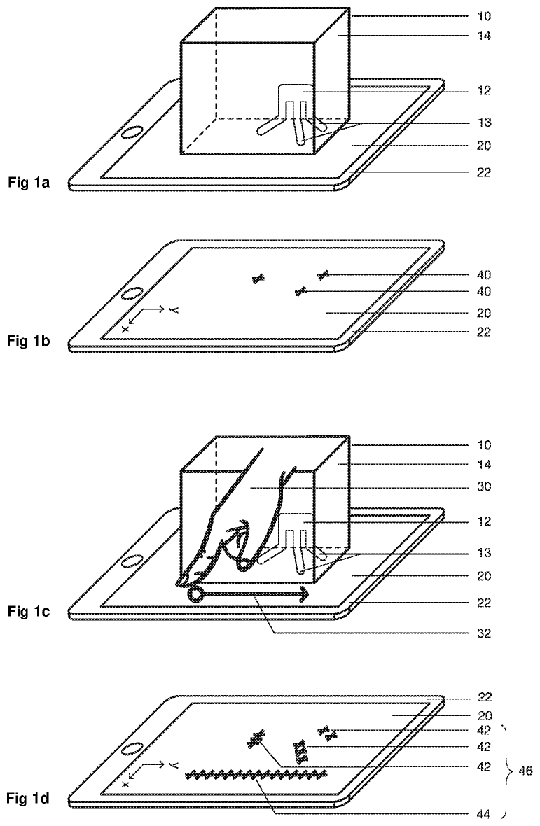

FIG. 1 shows a device (10) comprising an electrically conductive structure (12) comprising a plurality of structural elements (13) arranged on a non-conductive substrate (14) for generating a time-dependent overall signal (46) on a capacitive surface sensor (20), characterized in that the electrically conductive structure (12) of the device (10) generates a set of essentially static signals (40) on the capacitive surface sensor (20) and the static signals (40) are deflected and converted into dynamic signals (42) by an additional dynamic input by an input means (30).

In the illustrated embodiment, the device (10) represents a three-dimensional object, e.g., a folding box. The electrically conductive structure (12) is arranged on the bottom surface and a side surface of the three-dimensional object. In the exemplary embodiment, three structural elements (13) of the electrically conductive structure (12) are depicted. The bottom surface is in operative contact with the capacitive surface sensor (20) (FIG. 1a), and the structural elements (13) generate substantially static signals (40) on the capacitive surface sensor (20) (FIG. 1b) when the device (10) has been placed on said surface sensor (20). The positions of the static signals (40) correspond to the centroid of the surface of the structural elements (13).

FIG. 1c shows a dynamic input using an input means (30) on the capacitive surface sensor (20). In the embodiment a finger is used. The input occurs in a linear movement (32) along a side surface of the device (10). The input means (30) does not touch the electrically conductive structure (12).

FIG. 1d shows the dynamic input signal (44) generated by the dynamic input using an input means (30) and the deflected signals (42). The deflection of the signals is preferably in the direction of the input signal along the structural element (13). The entirety of the deflected signals (42) as well as the dynamic input signal (44) form the time-dependent overall signal (46), which can be evaluated by the device (22) containing the surface sensor (20).

It should be noted that the recorded signals are shown in the figures. For the person skilled in the art, it is understandable that, for example, the input signal (44) is created gradually on the surface sensor (20) during the input. In the sense of a suitable representation, the time-dependent signals have been “recorded” and the result shown.

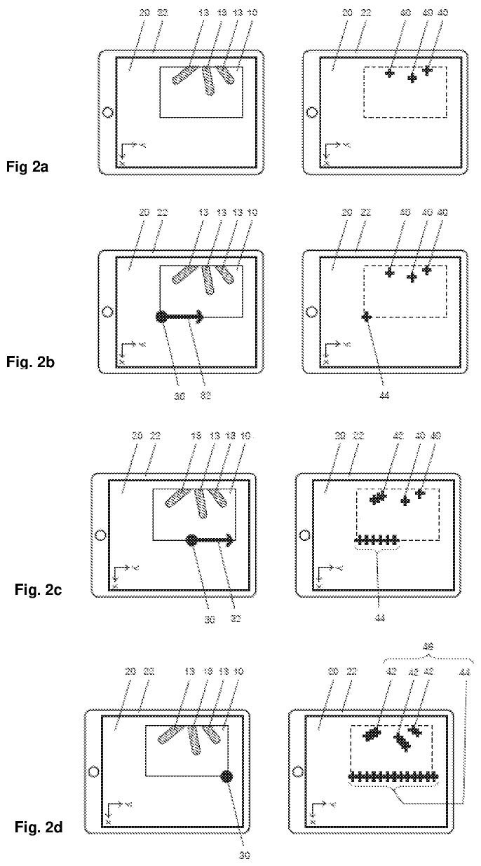

FIGS. 2a-d show the generation of the time-dependent overall signal (46) in a time sequence. To simplify the illustration, the bottom side of a three-dimensional object (10) comprising three structural elements (13) of the electrically conductive structure (12) is shown in each case. The input means (30) is shown in the form of a circle for simplicity. The signals (40, 42, 44, 46) generated on the capacitive surface sensor (20) are shown in the form of crosses representing the coordinates of the respective signals (40, 42, 44, 46). Again, the time-dependent signals were “recorded” and shown in collected form to track the history of the positions and the direction of movement of the signals. It should be noted that when the signals are deflected, the signals originally present in the initial position are not present at the time of the deflection, but are included here for better traceability.

FIG. 2a left shows the device (10) placed on the capacitive surface sensor (20). FIG. 2a right shows the substantially static signals (40) generated by the structural elements (13) of the electrically conductive structure (12) on the capacitive surface sensor (20). The position of the static signals (40) on the capacitive surface sensor (20) correspond to the centroids of the structural elements (13) of the electrically conductive structure (12).

FIG. 2b left shows additionally the input means (30) which is placed at the edge of the device (10) and generates an input signal (44) on the capacitive surface sensor (20) (FIG. 2b right). FIG. 2b represents the beginning of the dynamic input.

FIG. 2c left shows the progression of the dynamic input by input means (30) in the form of a linear movement (32) along the edge of the device (10). FIG. 2c right shows the evolving input signal (44) and the deflection of the static signal generated by the left of the three structural elements (13). A deflected signal (42) is generated at the point when the input means (30) and the structural element (13) are at the same level, i.e. interacting with the same row (not shown) of the capacitive surface sensor (20). The deflection of the signal is in the direction of the input signal (44) and occurs along the structural element (13). In other words, the design of the structural element (13) determines the direction and intensity of the deflection of the signal.

FIG. 2d left shows the completion of the movement of the input means (30) at the edge between the device (10) and the capacitive surface sensor (20). FIG. 2d right shows the overall dynamic signal (46) consisting of the deflected signals (42) and the dynamic input signal (44), which can be evaluated by the apparatus (22) containing the surface sensor (20).

The drawing illustrates that the substantially static signals (40) move along the structural elements (13) in the direction of the input means (30) and thus transform into dynamic signals (42).

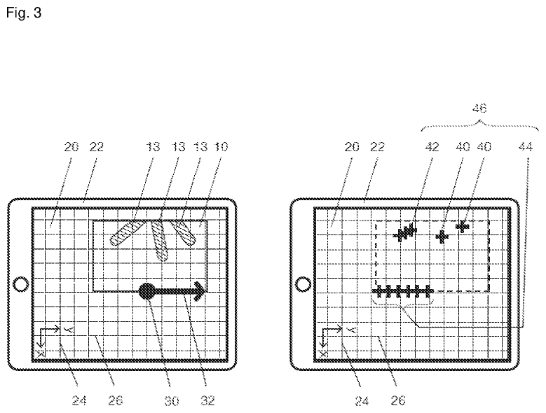

FIG. 3 shows a similar object as FIG. 2c, but supplemented by the representation of the electrode grid (24, 26) of the capacitive surface sensor (20). The rows (24) and columns (26) of the electrode grid are arranged orthogonally to each other. In the example shown, the input means (30) interacted with four electrode rows (24). Accordingly, the static signal (40) generated by the left of the three structural elements (13) has been deflected and converted into a dynamic signal (42) as said structural element interacts with at least one of these rows (24).

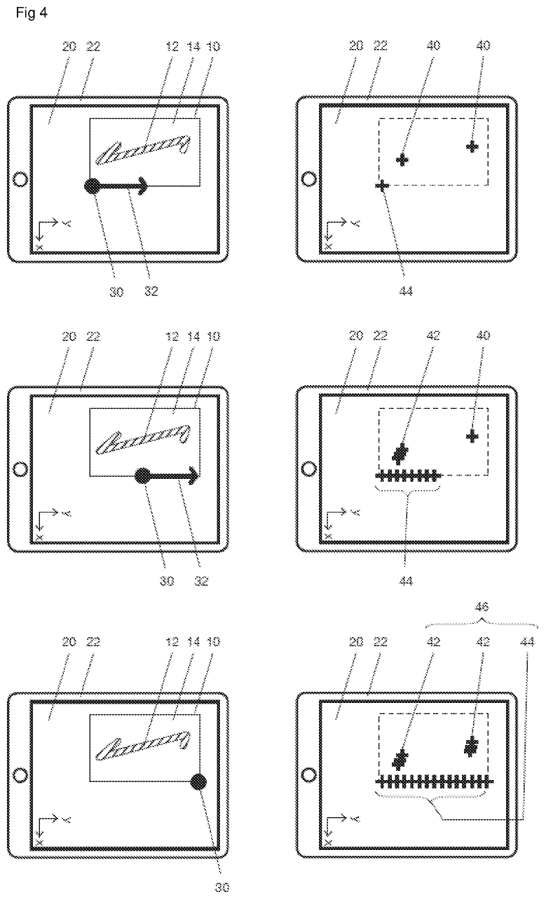

FIG. 4a-c shows the formation of the time-dependent overall signal (46) in a time sequence. The device (10) in the exemplary embodiment is a card-like object on which the electrically conductive structure (12) is arranged. The input means (30) is shown in the form of a circle for simplicity. The signals (40, 42, 44, 46) generated on the capacitive surface sensor (20) are shown in the form of crosses representing the coordinates of the respective signals (40, 42, 44, 46). Also in this case the time-dependent signals were “recorded” and shown in collected form to track the history of the positions and the direction of movement of the signals. It should be noted that when the signals are deflected, the signals originally present in the initial position are not present at the time of deflection, but are included in the illustration for better traceability.

FIG. 4a on the left shows the device (10) in the form of a card-shaped object placed on a capacitive surface sensor (20). The figure shows the input means (30) placed on the edge of the device (10), at the beginning of the movement. FIG. 4a right shows the static signals (40) generated by the electrically conductive structure (12) and the signal (44) generated by the input means (30).

FIG. 4b left shows the continuous movement (32) of the input means (30) along the edge of the device (10). FIG. 4b right shows the evolving input signal (44) and the deflection of the static signal generated by the left portion of the electrically conductive structure (12). A deflected signal (42) is created at this point when the input means (30) and static signal (40) are at the same level, i.e., interacting with the same row (not shown) of the capacitive surface sensor (20).

FIG. 4c left shows the completion of the movement of the input means (30) at the edge between the device (10) and the capacitive surface sensor (20). FIG. 4c right shows the overall dynamic signal (46) consisting of the deflected signals (42) and the dynamic input signal (44), which can be evaluated by the apparatus (22) containing the surface sensor (20).

The drawing illustrates that the substantially static signals (40) move along the electrically conductive structure (12) in the direction of the input means (30), thus converting them into dynamic signals (42).

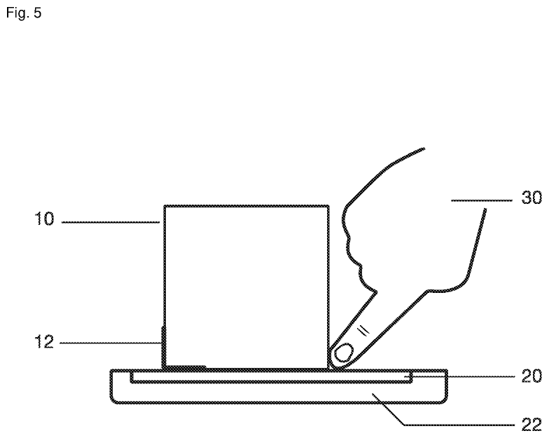

FIG. 5 shows the movement of an input means (30) along an edge formed between the surface sensor (20) and the device (10). The device (10) has an electrically conductive structure (12), which can be arranged on the bottom side and/or a side surface of the device (10), whereby the input means is not in contact with the electrically conductive structure (12). By moving the input means (30) along the transition area between the surface sensor (20) and the device (10), a dynamic input is preferably performed, which leads to a conversion of the static signals into dynamic signals.

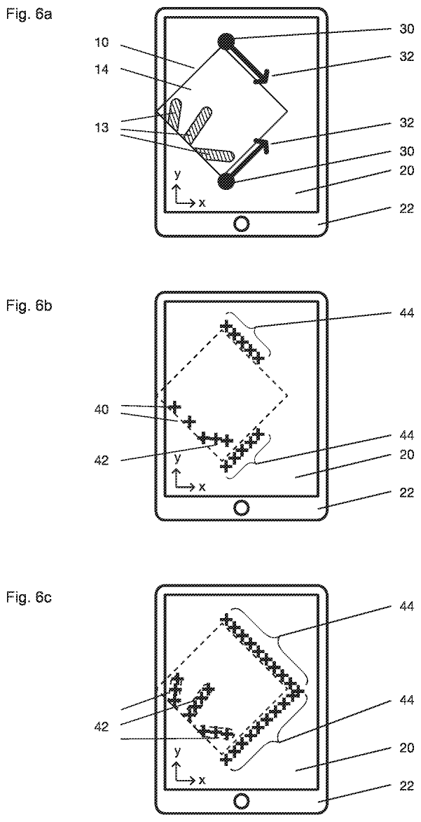

FIGS. 6a-c show a particular embodiment of the invention. The device (10) in the exemplary embodiment is a three-dimensional object on which the electrically conductive structure (12) comprising three structural elements (13) is arranged on the substrate material (14). In the present exemplary embodiment, two input means (30) are used, for example two fingers. The input means (30) are shown in the form of circles for simplicity. The signals (40, 42, 44, 46) generated on the capacitive surface sensor (20) are shown in the form of crosses representing the coordinates of the respective signals (40, 42, 44, 46). Also in this case the time-dependent signals were “recorded” and shown in collected form to track the history of the positions and the direction of movement of the signals. It should be noted that when the signals are deflected, the signals originally present in the initial position are not present at the time of deflection, but are included in the illustration for better traceability.

FIG. 6a shows the device (10) in the form of a three-dimensional object placed on a capacitive surface sensor (20). The figure shows two input means (30), each placed on two different edges of the device (10), at the beginning of the movement. The direction of movement (32) of the two input means (30) is shown by arrows. The movement (32) occurs along two edges of the object (10). In the present embodiment, the two input means (30) are preferably two fingers, for example the user's thumb and index finger. Both fingers are moved towards each other as shown by the arrows.

FIG. 6b shows the advancing input signals (44), the static signals (40) generated by the electrically conductive structure (12), and the deflection of the “bottom” static signal generated by the bottom structural element (13) of the electrically conductive structure (12). A deflected signal (42) is generated at the point when the lower input means (30) and the static signal (40) are at the same level, i.e., interacting with the same row (not shown) of the capacitive surface sensor (20).

FIG. 6c shows the complete input signals (44) and the deflected signals (42) after both input means (30) have been moved towards each other to the right edge of the object (10). The time-dependent overall signal (46) comprises the static signals (40), the deflected signals (42) and the input signals (44). For better clarity, the time-dependent overall signal (46) is not shown in this illustration.

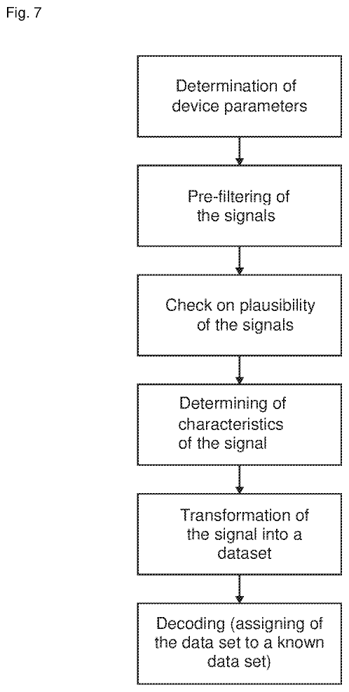

FIG. 7 shows the steps of processing and evaluating the touch events or touches with the help of a software program. Preferably, the device parameters of the apparatus containing the surface sensor, e.g. the resolution of the touch screen, are determined first. Depending on the device, the signal comprising a set of touch events is preferably pre-filtered in the next step and specific characteristics of the signal are amplified or adjusted. Subsequently, the signal is checked for plausibility by calculating parameters such as temporal course of the signal, velocity and data density, checking them for possible manipulation and comparing them with known threshold values. It is preferred that subsequently various characteristics and parameters of the signal are determined or calculated, including the characteristic values start of the signal, end of the signal, local maxima and minima, local velocities of the signal, displacement, amplitudes, if necessary period length of periodic signals and if necessary further characteristics, in order to convert the signal into a comparable data set. In particular, it is preferred to subsequently compare this data set with other data sets and to assign the data set to a known data set located, for example, in a database, and thus to decode the signal. In a further preferred embodiment, the matching of the data set takes place using a machine learning model (artificial neural networks) previously created from recordings. It was surprising that the use of a machine learning model to decode the signal is particularly suitable for complex signals with many different parameters.

### LIST OF REFERENCE SIGNS

10 Device

12 Electrically conductive structure

13 Structural elements of the electrically conductive structure

14 Substrate

20 Capacitive surface sensor

22 Apparatus comprising a capacitive surface sensor

24 Row of the electrode grid of the capacitive surface sensor

26 Column of the electrode grid of the capacitive surface sensor

30 Input means

32 Movement

40 Signal

42 Deflected signal

44 Input signal

46 Time-dependent overall signal

1. A method of generating a tamper-proof time-dependent signal on a surface sensor (20) comprising:
a) providing an apparatus (22) having a capacitive surface sensor (20) and a device (10) comprising an electrically conductive structure (12) having structural elements (13) on a non-conductive substrate (14) for generating static signals (40) on the capacitive surface sensor (20);
b) placing the device (10) on the surface sensor (20), thereby generating a set of static signals (40) on the surface sensor (20); and
c) providing a dynamic input in the form of a movement and/or a gesture with an input means for generating an input signal (44) which is suitable for deflecting the static signals (40) on the capacitive surface sensor (20) and converting the static signals (40) into dynamic signals (42) so that the dynamic input signal (44) and the dynamic signals (42) represent a time-dependent overall signal (46) which can be evaluated by the apparatus (22) containing the surface sensor (20).

2. The method according to claim 1,
characterized in that
each structural element (13) on the capacitive surface sensor generates a respective static signal (40), the signals (40) being essentially characterized by a time stamp information and a set of coordinate pairs.

3. The method according to claim 1
characterized in that
the deflection of the static signals (40) takes place at a time t when the respective structural elements (13) of the electrically conductive structure (12) and the input means (30) are in interaction with a same row (24) and/or a same column (26) of an electrode grid of the capacitive surface sensor (20).

4. The method according to claim 1,
characterized in that
the dynamic input comprises guiding the input means (30) over the surface sensor (20), which comprises at least sweeping rows (24) and/or columns (26) of the electrode grid on which the structural elements (13) of the device (10) are presently positioned.

5. The method according to any one of the preceding claims claim 1,
characterized in that
the dynamic input is performed by means of two or more input means (30).

6. The method according to claim 1,
characterized in that
the electrically conductive structure (12) and in particular the structural elements (13) determine the direction and intensity of the deflection of the signals (40) and the characteristics of the deflected signals (42).

7. The method according to claim 1,
characterized in that
the method comprises an evaluation of the time-dependent overall signal (46) by the apparatus (22) including the surface sensor (20), wherein in particular the amplitude and/or velocity of the deflection of the static signals (42) is determined in response to the dynamic input.

8. The method according to claim 1,
characterized in that
the device (10) is a card-shaped object.

9. The method according to claim 1,
characterized in that
the device is a three-dimensional object, a package or a folding box.

10. The method according to claim 1,
characterized in that
an edge of the device (10) is used for guiding an input by means of the input means (30).

11. A device (10) for generating a tamper-proof time-dependent signal on a surface sensor (20) in a method according to claim 1,
characterized in that
the device (10) comprises an electrically conductive structure (12) with structural elements (13) on a non-conductive substrate (14) for generating a time-dependent signal (46) on a capacitive surface sensor (20), wherein by placing the device (10) on a capacitive surface sensor (20) a set of essentially static signals (40) can be generated on the capacitive surface sensor (20), which can be deflected and converted into dynamic signals (42) by an additional dynamic input by means of an input means (30).

12. The device (10) according to claim 1,
characterized in that the
structural elements (13) are linear and have a width of 0.5 mm to 8 mm.

13. The device (10) according to claim 11
characterized in that
the device comprises at least one edge for guiding the input means (30) and predetermining a dynamic input signal (44), wherein the structural elements (13) are line-shaped and have an angle with the orthogonal of said edge of ±75°.

14. A system for generating a tamper-proof time-dependent signal (46) on a capacitive surface sensor (20), the system comprising a device (10) and an apparatus (22) comprising a capacitive surface sensor (20),
characterized in that
a) the device (10) comprises an electrically conductive structure (12) having structural elements (13) on a non-conductive substrate (14) adapted to generate a set of static signals (40) on the capacitive surface sensor (20),
b) the static signals (40) can be deflected and converted into dynamic signals (42) by an additional input by means of an input means (30) on the capacitive surface sensor (20), and
c) the dynamic input signal (44) generated by the input means (30) and the dynamic signals (42) represent a time-dependent overall signal (46) which is evaluated by the apparatus (22) comprising the surface sensor (20).

15. The system according to claim 14,
characterized in that
the electrically conductive structure (12), in particular the structural elements (13) and/or the input means (30) can be brought into operative contact with the capacitive surface sensor (20).

16. The system according to claim 14
characterized in that
the system comprises a data processing device which is adapted to evaluate the time-dependent overall signal (46), wherein preferably on the data processing device a software (‘app’) is installed comprising commands for determining dynamic characteristics of the time-dependent overall signal (46) and comparing the dynamic characteristics with reference data.

17. The system according to claim 16
characterized in that
the apparatus (22) including the surface sensor (20) processes the time-dependent overall signal (46) as a set of touch events and the software determines dynamic characteristics of the set of touch events.

18. The system according to claim 16
characterized in that
the dynamic characteristics comprise a start, an end, local maxima, local minima, velocities, deflections and/or amplitudes of touch events.

19. A kit for carrying out a method according to claim 1 comprising
a) a device (10) comprising an electrically conductive structure (12) with structural elements (13) on a non-conductive substrate (14) for generating a time-dependent overall signal (46) on a capacitive surface sensor (20), wherein by placing the device (10) on a capacitive surface sensor (20) a set of essentially static signals (40) can be generated on the capacitive surface sensor (20), which can be deflected by an additional dynamic input by means of an input means (30) and converted into dynamic signals (42), and
b) a software (‘app’) for installation on an apparatus (22) including a surface sensor (20), comprising commands to determine dynamic characteristics of the time-dependent overall signal (46) and to compare the dynamic characteristics with reference data
characterized in that
the visually marked input areas (16) are strip-shaped input areas, the ends of which are marked with numbers, letters, and/or symbols, and wherein the electrically conductive structure (12) comprises multiple line-shaped single elements (14) and each strip-shaped area overlaps with at least one line-shaped single element (14), wherein preferably the line-shaped single elements (14) are arranged orthogonally to the input areas (16) and have different lengths.
